(19) United States
(12) Patent Application Publication
(10) Pub. No.: US 2014/0135086 A1
(43) Pub. Date: May 15, 2014

(54) System and Method for a Network-Based Strategy Game Based on Live Sporting Events

(71) Applicants: Marisa Ingemi, Amherst, NH (US); Christine Ingemi, Amherst, NH (US); Richard Ingemi, Amherst, NH (US)

(72) Inventors: Marisa Ingemi, Amherst, NH (US); Christine Ingemi, Amherst, NH (US); Richard Ingemi, Amherst, NH (US)

(21) Appl. No.: 14/080,286

(22) Filed: Nov. 14, 2013

Related U.S. Application Data
(60) Provisional application No. 61/726,818, filed on Nov. 15, 2012.

(51) Int. Cl. A63F 13/30

(52) U.S. Cl. CPC A63F 13/12
USPC 463/9

(57) ABSTRACT

A network-based strategy game based on live sporting events contains a processor and a computer readable storage medium tangibly embodying code executed by the processor to cause operations to be performed. At least one strategy question with multiple choice answers is electronically published during a sporting event relating to an impending coaching decision of the sporting event via at least one network connection of a computerized data processing apparatus. A user answer selected from the multiple choice answers published by each of a plurality of game users is recorded. A coaching answer is selected from the multiple choice answers that correlate to a coaching decision made by a coach with the impending coaching decision is recorded. The success of the coaching decision is recorded. Data correlating at least two of: the recorded user answers, the recorded coaching answer, and the recorded successfulness of the coaching decision, is published.

### CROSS REFERENCE TO RELATED APPLICATION

This application claims benefit of U.S. Provisional Application Ser. No. 61/726,818 entitled, “SYSTEM AND METHOD FOR A NETWORK-BASED STRATEGY GAME BASED ON LIVE SPORTING EVENTS” filed Nov. 15, 2012, the entire disclosure of which is incorporated herein by reference.

### FIELD

The present disclosure is generally related to a strategy game and, more particularly, is related to a system and method for system and method for a network-based strategy game based on live sporting events.

### BACKGROUND

Many online games exist related to live sporting events. Fantasy sport games are one example. In most fantasy sports, game players choose players from the events to populate their teams and the statistics accumulated by the event players then populate the teams of the game players. Some have suggested that fantasy sports have broadened the fan base for the real sport. While there may exist strategy for choosing players, the strategy employed by the coaches of the real team in the sporting event has minimal impact on the fantasy sport game. Similarly, the outcome of the real sporting event has no impact on the fantasy game. In this regard, the fantasy game creates a real disconnect for fantasy game players from the real sporting event.

It has also been suggested that gambling, as associated with sport books, has broadened the fan base for various real sporting events. Gambling may include betting on outcomes, betting against point spreads, and proposition betting (specific outcomes during the real sporting event). However, gambling is largely insulated from the strategy of the sporting event and creates a disconnection from the strategy of the real sporting event similar to a fantasy game. Thus, a heretofore unaddressed need exists in the industry to address the aforementioned deficiencies and inadequacies by creating a game played in parallel to the real sporting event that meshes with the strategy of the real sporting event.

### SUMMARY

Embodiments of the present disclosure provide a system and method for a network-based strategy game based on live sporting events. Briefly described, in architecture, one embodiment of the system, among others, can be implemented as follows. The system contains a processor and a computer readable storage medium tangibly embodying code executed by the processor to cause operations to be performed. One of the operations is electronically publishing at least one strategy question during a sporting event relating to an impending coaching decision of the sporting event via at least one network connection of a computerized data processing apparatus. Another operation is electronically publishing multiple choice answers to be at least one strategy question. Another operation is recording a user answer selected from the multiple choice answers published from each of a plurality of game users. Another operation is recording a coaching answer selected from the multiple choice answers that correlate to a coaching decision made by a coach with the impending coaching decision. Another operation is recording whether the coaching decision was successful, whereby successful is based on pre-established guidelines of success. Another operation is publishing data correlating at least two of: the recorded user answers, the recorded coaching answer, and the recorded successfulness of the coaching decision.

The present disclosure can also be viewed as providing methods for providing a network-based strategy game based on live sporting events. In this regard, one embodiment of such a method, among others, can be broadly summarized by the following steps: electronically publishing at least one strategy question during a sporting event relating to an impending coaching decision of the sporting event via at least one network connection of a computerized data processing apparatus having a processor and a computer readable storage medium containing the code to publishing data on the computer network; electronically publishing multiple choice answers to the at least one strategy question across the computer network; recording a user answer from the multiple choice answers published from each of a plurality of game users selecting remotely on the computer network; recording a coaching answer selected from the multiple choice answers that correlate to a coaching decision made by a coach participating in the sporting event; recording whether the coaching decision was successful, whereby successful is based on pre-established guidelines of success; and publishing data on the computer network correlating at least two of: the recorded user answers, the recorded coaching answer, and the recorded successfulness of the coaching decision.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale. Instead emphasis is being placed upon illustrating clearly the principles of the present disclosure. Moreover, in the drawings, like reference numerals designate corresponding parts throughout the several views.

FIG. 1 is a schematic illustration of a general-purpose computer 10, in accordance with a first exemplary embodiment of the present disclosure.

FIG. 2 is a block diagram illustrating operation of a strategy game based on live sporting events, in accordance with the first exemplary embodiment of the present disclosure.

FIG. 3 is an illustration of a flowchart illustrating a method of using the strategy game based on live sporting events of FIG. 1, in accordance with the first exemplary embodiment of the present disclosure.

FIGS. 4A & 4B is an illustration of a flowchart illustrating a method of using the strategy game based on live sporting events of FIG. 2, in accordance with a second exemplary embodiment of the present disclosure.

### DETAILED DESCRIPTION

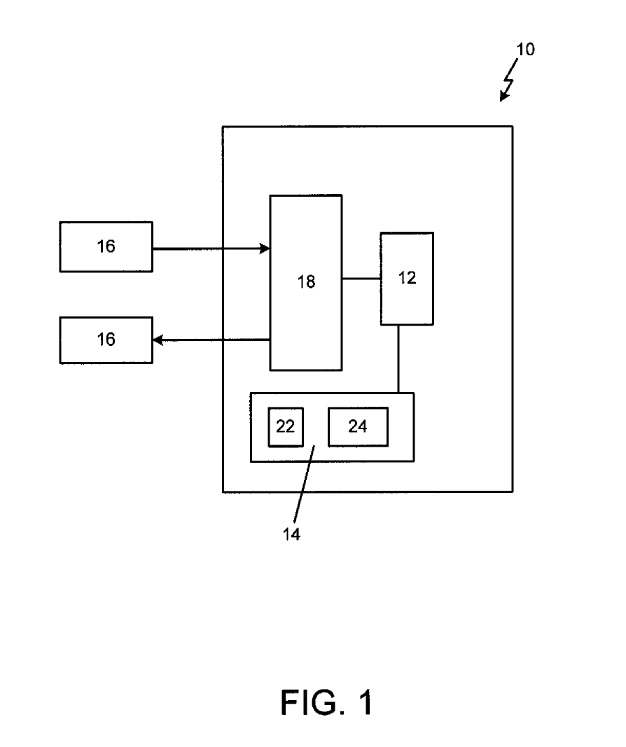

FIG. 1 is a schematic illustration of a general-purpose computer 10, in accordance with a first exemplary embodiment of the present disclosure. The general-purpose computer 10, which may be referred to simply as ‘computerized device 10’ or ‘computer 10’ herein, may include any components, in whole or in part, commonly used with a computerized device, but may also include a variety of additional components. Accordingly, the computer 10 of FIG. 1 is to provide clarity in describing the general functioning of a computing system and is not considered limiting to the present disclosure.

The computerized device 10 may include a variety of computer-based components, in whole and in part. For example, the computerized device 10 may be implemented in software (e.g., firmware), hardware, or a combination thereof. Commonly, the computerized device 10 is implemented with both hardware and software, such as a hard drive or memory that stores processor-executable code portions for carrying out instructions, calculations, or other tasks. The software or programmable code may be executed by any special or general-purpose digital computer, such as a personal computer (PC; IBM-compatible, Apple-compatible, or otherwise), workstation, minicomputer, smart phone, tablet computer, or mainframe computer.

In terms of hardware architecture, as shown in FIG. 1, the computer 10 includes a processor 12, memory 14, and one or more input and/or output (I/O) devices 16 (or peripherals) that are communicatively coupled via a local interface 18 (I/O interface). The local interface 18 can be, for example but not limited to, one or more buses or other wired or wireless connections, as is known in the art. The local interface 18 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 12 is a hardware device for executing software, particularly that stored in the memory 14. The processor 12 can be any custom made or commercially available processor, a central processing unit (CPU), an auxiliary processor among several processors associated with the computer 10, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium or Core series microprocessor from Intel Corporation, a PowerPC microprocessor from IBM, an A Series processor from Apple Computers, Inc., a Sparc microprocessor from Sun Microsystems, Inc, a 68xxx series microprocessor from Motorola Corporation, an Athlon or Sempron processor from AMD.

The memory 14, which may include any number of databases, may include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 14 may incorporate electronic, magnetic, optical, and/or other types of storage media. Note that the memory 14 can have a distributed architecture, where various components are situated remote from one another, but can be accessed by the processor 12. For example, the memory 14 may have a partitioned drive for storage of data in separate and distinct areas with communication therebetween through the processor 12.

The software in the memory 14 may include one or more programmable code sections or separate programs, each of which comprises an ordered listing of executable instructions for implementing logical functions. In the example of FIG. 1, the software in the memory 14 may include an operating system (O/S) 22, which manages computer hardware resources and provides common services for execution of various software applications 24. A nonexhaustive list of examples of suitable commercially available operating systems 22 includes Windows operating system available from Microsoft Corporation, a Netware operating system available from Novell, Inc., a Macintosh operating system or the OS X—each available from Apple Computer, Inc., a UNIX operating system, which is available for purchase from many vendors, such as the Hewlett-Packard Company, Sun Microsystems, Inc., and AT&T Corporation, a LINUX operating system, which is freeware that is readily available on the Internet, Android operating system available from Google, Inc., a run time Vxworks operating system from WindRiver Systems, Inc., and an appliance-based operating system, such as that implemented in handheld computers or personal data assistants (PDAs) (e.g., PalmOS available from Palm Computing, Inc., and Windows CE available from Microsoft Corporation), tablet computers, smart phones and other mobile computing devices.

The operating system 22 may control the execution of other computer programs, namely software applications 24, and provides scheduling, input-output control, file and data management, memory management, and communication control and related services. The software applications 24 may include any type of computer program or software that is installed, downloaded, or otherwise stored, at least in part, in the memory 14. Software applications 24 may include activity or function-specific programs and general functioning programs. For example, a nonexhaustive list of software applications 24 includes programs for word processing (i.e., MS Office Suite available from the Microsoft Corporation), data-processing, image processing (i.e., Creative Suite or Adobe Reader available from Adobe Systems, Inc.), gaming, anti-virus, and communication (i.e., communication software offered by Skype Software S.à r.l), or any other software program. Additionally, it is noted that software applications 24 may be referenced herein as ‘Apps.’

The software application 24 on the computer 10 may include a source program, executable program (object code), script, or any other entity comprising a set of instructions to be performed. When software application 24 includes a source program, then the program needs to be translated via a compiler, assembler, interpreter, or the like, which may or may not be included within the memory 14, so as to operate properly in connection with the O/S 22. Furthermore, the software application 24 may be written as an object oriented programming language, which has classes of data and methods, or a procedure programming language, which has routines, subroutines, and/or functions, for example but not limited to, C, C++, Pascal, Basic, Fortran, Cobol, Perl, Java, Flash, and Ada. The software application 24 may also include or be compatible with any type of database programs, such as MYSQL or Oracle.

The I/O devices 16 may include input devices, for example but not limited to, a keyboard, mouse, scanner, microphone, touchscreen, communication connection, or other computerized device, etc. Furthermore, the I/O devices 16 may also include output devices, for example but not limited to, a printer, display, etc. The I/O devices 16 may further include devices that communicate both inputs and outputs, for instance but not limited to, a modulator/demodulator (modem; for accessing another device, system, or network), a radio frequency (RF) or other transceiver, a telephonic interface, an interactive television, a bridge, a router, etc.

If the computer 10 is a PC, workstation, or the like, the software in the memory 14 may further include a basic input output system (BIOS) (omitted for simplicity). The BIOS is a set of essential software routines that initialize and test hardware at startup, start the O/S 22, and support the transfer of data among the hardware devices. The BIOS is stored in ROM so that the BIOS can be executed when the computer 10 is activated. When the computer 10 is in operation, the processor 12 is configured to execute software stored within the memory 14, to communicate data to and from the memory 14, and to generally control operations of the computer 10 pursuant to the software. The O/S 22, in whole or in part, but typically the latter, are read by the processor 12, perhaps buffered within the processor 12, and then executed.

The computer 10 can include software applications 24 which can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The computer 10 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Alternatively, functioning of the computer 10 may be implemented in hardware, which may require any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It is noted that the computer 10 may be a single unitary device having the various components housed therein, or a plurality of interconnected devices connected through a communication connection. Communication connections may include wired connections, wireless connections, connections through other devices (servers), and connections through a network. For example, a plurality of computers 10 may be connected together via a network connection such as the Internet, an extranet, or any other cloud-based network where communication is facilitated. The components of the computer 10, such as the memory 14, may be housed and/or stored remote from the processor 12, or other components, and communicate through a network connection. Any configuration of the components of the computer 10 may be possible.

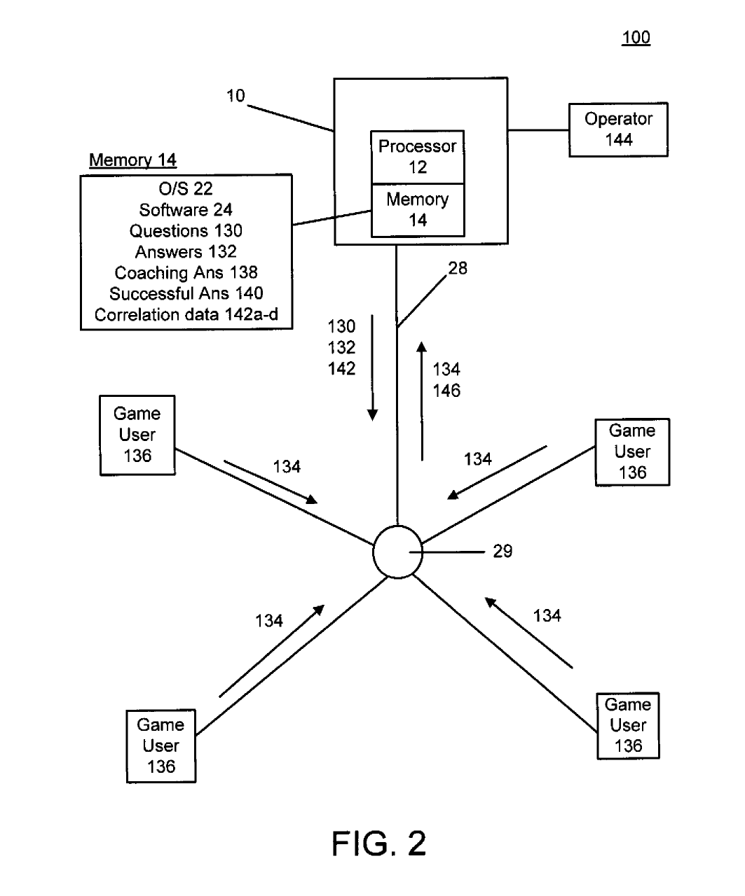

FIG. 2 is a block diagram illustrating operation of a strategy game system 100 based on live sporting events, in accordance with a first exemplary embodiment of the present disclosure. The system 100 contains the processor 12 and a computer readable storage medium 14 tangibly embodying code executed by the processor 12 to cause operations to be performed. One of the operations is electronically publishing at least one strategy question 130 during a sporting event relating to an impending coaching decision of the sporting event via at least one network connection 28 of a computerized data processing apparatus 10 to a computer network 29. Another operation is electronically publishing multiple choice answers 132 to the at least one strategy question 130 to the computer network 29. Another operation is recording a user answer 134 selected from the multiple choice answers published from each of a plurality of game users 136. Another operation is recording a coaching answer 138 selected from the multiple choice answers that correlate to a coaching decision made by a coach with the impending coaching decision. Another operation is recording whether the coaching decision was successful 140, whereby successful is based on pre-established guidelines of success. Another operation is publishing data 142 correlating at least two of: the recorded user answers 134, the recorded coaching answer 138, and the recorded successfulness 140 of the coaching decision.

The strategy question 130 may depend largely upon the sport. Examples of strategy questions 130 in football may include choosing to call a run or pass at a specific moment in the game, kick or go for it on fourth down, choosing which running back to use, choosing to challenge a call on the field, etc. Examples of strategy questions in baseball include whether to steal, whether to walk a player intentionally, whether to pinch hit, whether to change pitchers, etc. Every sport having a modicum of strategy and coaching decisions allows for this type of game.

Many of the strategy questions 130 may be stored in the computer readable storage medium 14 in advance of the game, allowing an operator 144 to publish an appropriate strategy question 130 with a single stroke or command on an input device or allowing an electronic agent to prompt an appropriate strategy question 130. As sporting events will have common repeating events and situations, many of the strategy questions may be fungible. For example, many baseball games will feature 2 pitchers getting up in the bullpen to warm up when a manger is thinking about taking out the starting pitcher. After the relief pitchers start warming up, a strategy question may be “What would you do with [Starting Pitcher's Name]?” and the multiple choice answers may be: 1) “leave him in”; 2) “replace him with [First Relief Pitcher's Name]”; and 3) “replace him with [Second Relief Pitcher's Name].” The bracketed fields may be variable fields fed names from an automatic feed from the game reporting event characteristics that include an identity of the pitcher in the game and the identity of pitcher(s) warming up in the bullpen. This type of question may be automatically prompted each game without the intervention of an operator.

In a football game, each fourth down, a fungible strategy question would be, “What would you do here?” with the answers: 1) “go for a first down”; 2) “kick a field goal”; and 3) “punt”. The optional choice of “kick a field goal” may be based on whether the ball is spotted within 40 yards of the end zone, thus making a field goal a possibility. Again, this question is a fungible strategy question that can be prompted without operator intervention. Elements of the fungible strategy question 130, including which questions 130 are appropriate, which multiple choice answers 132 should be made available, and what information may be fed into variable fields of the question 130 or answers 132, may originate with a data feed 146 coming in through the computer network 29. The software 24 in the storage medium 14 provides instruction to the processor 12 for both the reception and use of the information in the data feed.

The strategy question 130 will be published with multiple choice answers 132. The multiple choice answers 132 may allow game users 136 to respond to the strategy question 130 with a single keystroke or command. The multiple choice answers 132 may be limited to two answers or may be limited to a larger, finite number of answers. Just as some of the strategy questions 130 may be stored in the computer readable storage medium 14 in advance of the game, so too may the multiple choice answers 132, to the extent they may be known in advance of the game. For a question such as, ‘Which pitcher should the manager bring into the game?’ the system 100 may have the team rosters stored in advance of the game and automatically prompt the operator 144 with all of the available pitchers. The operator 144 may then choose to publish all of the available pitchers as the multiple choice answer 132 for that question or select a subset of the available pitchers to publish as answers 132. While storing questions 130 and answers 132 in the computer readable storage medium 14 is contemplated, nothing in this disclosure limits the system 100 from allowing the operator to input answers 132 and questions 130 during a game.

The game users 136 will provide user answers 134 during the game. As can be appreciated, a question 130 such as ‘should the manager pinch hit for Smith?’ preferably will not be published until it is Smith's turn to bat and may have a very limited temporal window for a user to answer before the manager's decision is announced. The temporal window to answer may be fixed at the moment the question 130 is published or may be open until the operator 144 determines the baseball manager has announced his intention, at which point the operator 144 closes the window to answer without warning to the game users 136. The game users 136 may be able to provide the user answers 134 by text, email, selection in a web site, selection in an app within a mobile device, or in any other way that technology allows. The user answers 134 may be stored on a computer, phone, mobile device, or similar device and transmitted from the game user 136 at the completion of the game. As long as the system 100 prevents the game user 136 from adding user answers 134 or tampering with user answers 134 after the temporal window closes, it is not necessary for the user answers 134 to get recorded in the computer readable storage medium 14 during the game. However, it may be advantageous to allow transmission of user answers 134 to the computer readable storage medium 14 during the game to allow the operator 144 to publish aggregated user answers 134 during the game.

The game users 136 may use dedicated devices to provide their user answers. For instance, a stadium may provide its fans with dedicated devices for answering strategy questions 130 during a game. The dedicated devices may be hardwired or otherwise anchored into a seat, which may be used to provide rewards or merchandise offers to game users 136 during the game. Aggregated user answers 134 may be displayed on a stadium display for the game fans as the user answers 134 are entered or after they are entered. Game users 136 at a stadium using a dedicated device may be allowed to transmit their user answers 134 through the computer network 29 to their own email address, phone, account in the system 100, or other data retrieval destination.

The strategy questions 130 are intended to mimic coaching decisions. As such, when a coach makes a decision related to one of the strategy questions 130 during the game, the operator may correlate that decision against the multiple choice answers 132 for that strategy question 130 and designate one of the multiple choice answers 132 as the coaching answer 138. The coaching answer 138 may be recorded for every strategy question 130. The coaching answer 138 may be recorded in the computer readable storage medium 14 during the game and/or after the game.

If a strategy question 130 did not have a multiple choice answer 132 that correlates to the coach's decision, that strategy question 130 and any related user answers 134 may be purged from the system 100. For example, in the 12^{th} inning of a game, the strategy question 130 may be ‘Which Boston pitcher should start the next inning?’ and may publish the remaining eligible pitchers as the multiple choice answers 132. If the manager starts the inning with a position player pitching (thus their name was not offered as one of the multiple choice answers 132) or if the game is canceled at that moment due to rain, that particular question 130 and any related user answers 134 may be purged.

The system 100 will also record whether a strategy decision was successful. How success is measured will be established by the operator 144 in advance of the game. Successful in baseball may be based on whether the next play resulted in an out or whether a run was scored in the inning after the decision. Successful in football may be based on yards gained or scoring points during the possession. However successful is determined, preferably the game users 136 are informed of the basis in advance of the game. Game users 136 may establish leagues to play against friends and may establish their own system for determining whether a play is successful for their league. The successful answer (or the successfulness of the coaching answer) 140 is recorded in the computer readable storage medium 14 during and/or after the game.

The system 100 further allows for creation of correlation data 142 correlating at least two of the user answers 134, the coaching answer 138, and the successful answer 140. The system 100 may create correlation data 142a correlating user answers 134 and coaching answers 138. The coaching/user correlation data 142a may allow for the determination of how frequently a majority of a team's fan base agrees with their team's coach or manager. The coaching/user correlation data 142a may allow the system 100 to inform a game user 136 to which coach their strategies most closely relate. A baseball fan with a slow hook and strong desire to sacrifice bunt may be told they coach like Dusty Baker, while a fan with a quick hook and a penchant for the hit-and-run may be told they coach like Tony LaRussa. Also, the coaching/user correlation data 142a may be used to rate coaches relative to how frequently or infrequently their decisions were consistent with a majority of the fans.

The system 100 may create correlation data 142b correlating user answers 134 with successful answers 140. The user/success correlation data 142b may be used to establish fantasy leagues based on coaching strategy. Each game user 136 may score points based on each user answer 134 they offer that matches a successful answer 140. Each game user 136 may also lose points based on each user answer 134 they offer that does not match a successful answer 140. In this regard, a fantasy league may be developed that brings fans deeper into the strategy of the game and directs attention to the game itself rather than simply the statistics that are accumulated.

The system 100 may also create correlation data 142c correlating coaching answers 138 with successful answers 140. The correlation data 142c may be used to rate how effectively the coach managed the game based on how frequently the coaching answers 138 matched with successful answers 140.

The system 100 may also create correlation data 142d correlating user answers 134, coaching answers 138, and successful answers 140. The correlation data 142d may be reviewed to determine how frequently a coaching answer 138 went against the common/popular user answer 134 and was a successful answer 140. Similarly, the correlation data 142d may be used to determine how frequently a coaching answer 138 was not a successful answer 140, but was a popular user answer 134. A coaching rating system may be developed, for instance that awards points based on how frequently a coaching answer 138 matched a successful answer 140 plus the frequency a coaching answer 138 that did not match a successful answer 140 nonetheless matched the most popular user answer 134. For NFL football, which currently allows challenges to referee decisions, the coaching rating system may incorporate the percentage of successful challenges. Also, the strategy questions 130 may include a question of whether the coach should challenge a referee decision with binary answer choices 132. Other coaching rating systems may be developed based on this correlation data 142d.

Data relating to game users 136 may be collected passively or actively. Data such as teams a game user 136 follows, frequency of game watching, location when using the system 100, and varying strategy decisions over time may be captured passively. Data including hometown, age, and favorite teams are examples of data that could be collected actively. Other data may be collected passively or actively and the aforementioned data possibilities are not an exhaustive list of data that may be of interest.

The correlation data 142 may be filtered. The filter may be used to categorize different types of strategy questions 130, to group different types of user answers 134, to isolate age groups of game users 136, user locations, game users 136 by teams they support, or any other type of data that may be collected relative to the game users 136. Game users 136 may be able to separate out data relating to their user answers 134 and compare it to user answers 134 from one or a group of other game users 136.

Filtered user answers 134 may be used for scientific research, to analyze: risk aversion of the general sport fans against the risk aversion of fans for a specific team; comparative decision-making trends of game users 136 in different geographies; whether decision making changes when facing a team rival as opposed to other teams in the league; changes in game user 136 decision making over time as interaction with the system 100 impacts game user 136 decision making; and whether coach popularity has a stronger relationship to decision making that disagrees with common user answers 134 than frequency of wins recorded. Other research ideas may be obvious to those with ordinary skill the art.

The system 100 may publish to the game user 136 statistics or related historical data showing a team or coach's past decision making. The statistics or related historical data may be related to the game situation occurring in real time to give the game user 136 an idea of what event is likely to occur.

The system 100 may include common online social networking devices, including chat rooms, connecting with friends, connecting with fans with similar interests, message boards, sharing information, sharing fan photos and game schedules, incentives for recruiting friends, advertising, and receiving and posting comments automatically from a game user's 136 posting on another social networking site. The system 100 may allow game users 136 to compare user answers 134 in real time and to call attention to a specific friend's user answer 134 in a message board comment. Each user answer 134 may be linked to the correlating strategy question 130 and multiple choice answers 132 for reference later, as well as a text description of the play that ultimately occurred and/or a video or audio clip of the play that ultimately occurred. Team web pages or team fan pages may post the correlation data 142 from game users 136 that have registered as fans of the team. Similarly, game users 136 may make comments in team forums or message boards second guessing a coaching answer 138 with a link back to their own user answer 134 to show they believed the coach was making the wrong call in the moment.

While “team” and team sport terms are mentioned repeatedly herein, sports that do not use teams or rely as heavily on coaches, such as tennis or golf, can similarly be followed for strategy decisions without departing from the inventive concepts described herein.

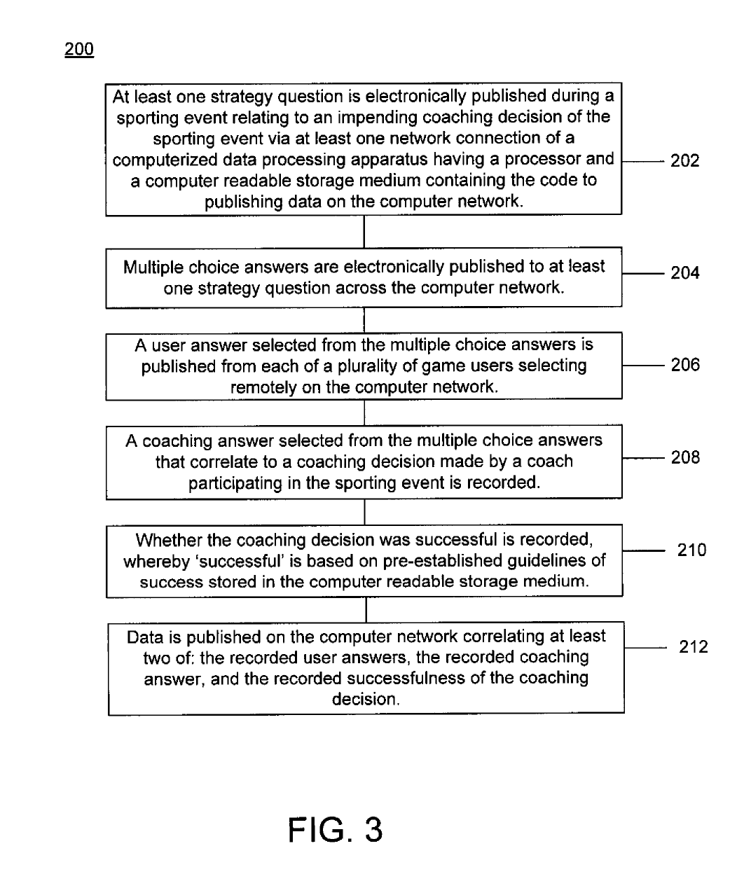

FIG. 3 is an illustration of a flowchart 200 illustrating a method of using the strategy game based on live sporting events of FIG. 2, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 202, at least one strategy question is electronically published during a sporting event relating to an impending coaching decision of the sporting event via at least one network connection of a computerized data processing apparatus having a processor 12 and a computer readable storage medium 14 containing the code to publishing data on the computer network 29. Multiple choice answers 132 are electronically published to at least one strategy question 130 across the computer network 29 (block 204). A user answer 134 selected from the multiple choice answers 132 is published from each of a plurality of game users 136 selecting remotely on the computer network 29 (block 206). A coaching answer 138 selected from the multiple choice answers 132 that correlate to a coaching decision made by a coach participating in the sporting event is recorded (block 208). Whether the coaching decision was successful is recorded 140, whereby ‘successful’ is based on pre-established guidelines of success stored in the computer readable storage medium 14 (block 210). Data 142 is published on the computer network 29 correlating at least two of: the recorded user answers 134, the recorded coaching answer 138, and the recorded successfulness of the coaching decision 140 (block 212).

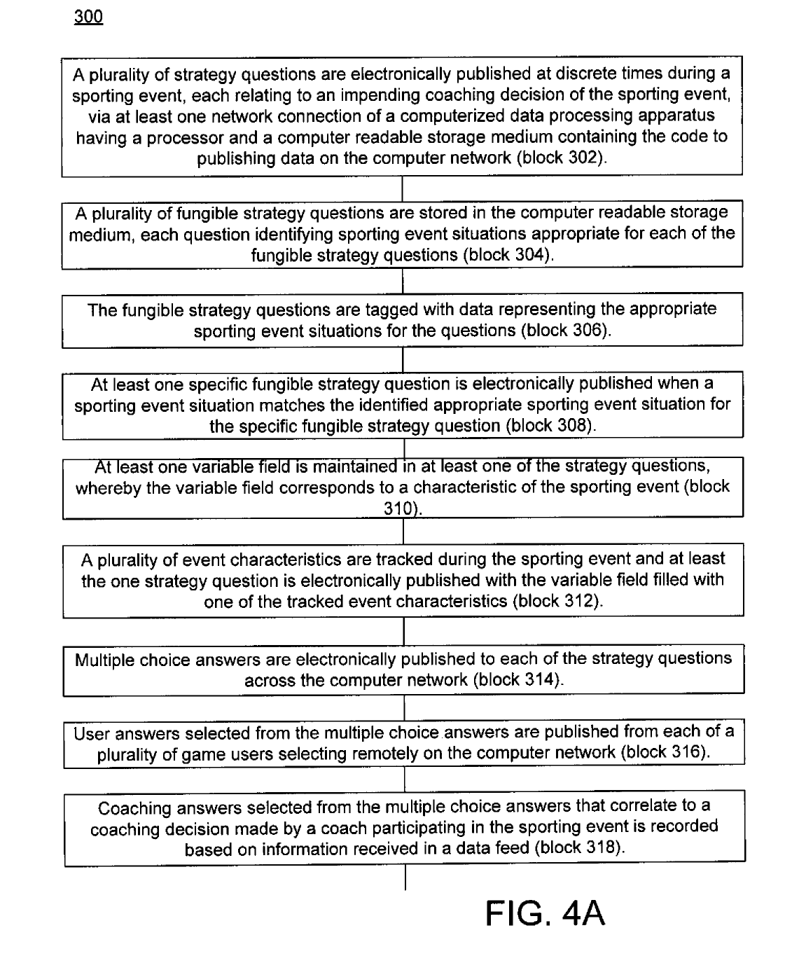

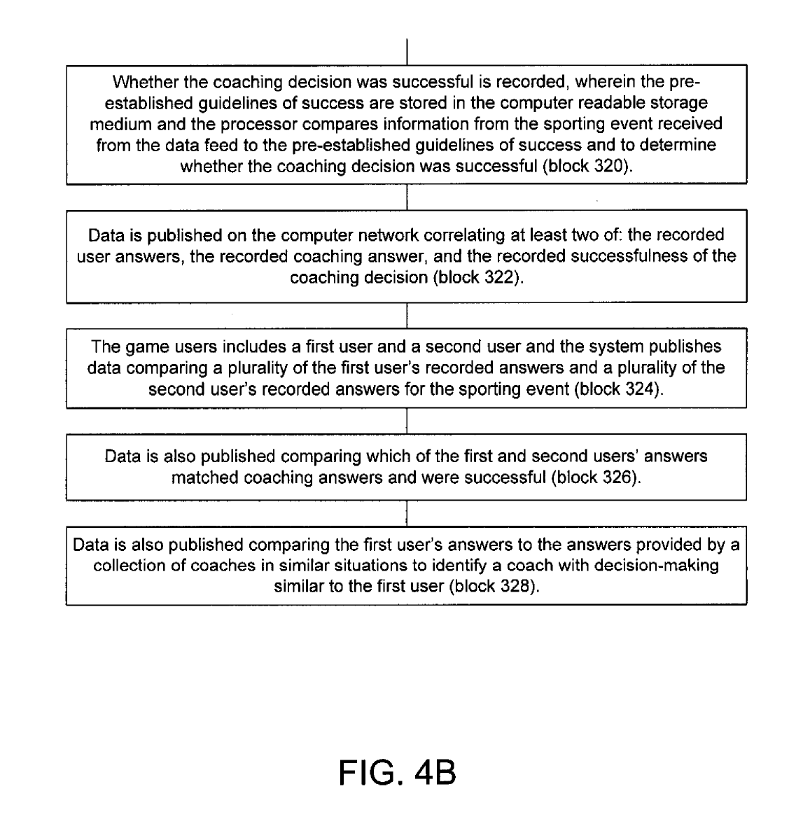

FIGS. 4A & 4B is an illustration of a flowchart 300 illustrating a method of using the strategy game based on live sporting events of FIG. 2, in accordance with a second exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 302, a plurality of strategy questions 140 are electronically published at discrete times during a sporting event, each relating to an impending coaching decision of the sporting event, via at least one network connection 28 of a computerized data processing apparatus 10 having a processor 12 and a computer readable storage medium 14 containing the code to publishing data on the computer network 29. A plurality of fungible strategy questions 130 are stored in the computer readable storage medium, each question identifying sporting event situations appropriate for each of the fungible strategy questions 130 (block 304). The fungible strategy questions 130 are tagged with data representing the appropriate sporting event situations for the questions 130 (block 306). At least one specific fungible strategy question is electronically published when a sporting event situation matches the identified appropriate sporting event situation for the specific fungible strategy question (block 308). At least one variable field is maintained in at least one of the strategy questions 130, whereby the variable field corresponds to a characteristic of the sporting event (block 310). A plurality of event characteristics are tracked during the sporting event and at least the one strategy question is electronically published with the variable field filled with one of the tracked event characteristics (block 312). Multiple choice answers are electronically published to each of the strategy questions across the computer network (block 314). User answers selected from the multiple choice answers 132 are published from each of a plurality of game users selecting remotely on the computer network 29 (block 316). Coaching answers selected from the multiple choice answers that correlate to a coaching decision made by a coach participating in the sporting event is recorded based on information received in a data feed (block 318). Whether the coaching decision was successful is recorded, wherein the pre-established guidelines of success are stored in the computer readable storage medium and the processor compares information from the sporting event received from the data feed to the pre-established guidelines of success and to determine whether the coaching decision was successful (block 320). Data is published on the computer network 29 correlating at least two of: the recorded user answers, the recorded coaching answer, and the recorded successfulness of the coaching decision (block 322). The game users includes a first user and a second user and the system 10 publishes data comparing a plurality of the first user's recorded answers and a plurality of the second user's recorded answers for the sporting event (block 324). Data is also published comparing which of the first and second users' answers matched coaching answers and were successful (block 326). Data is also published comparing the first user's answers to the answers provided by a collection of coaches in similar situations to identify a coach with decision-making similar to the first user (block 328).

It should be emphasized that the above-described embodiments of the present disclosure, particularly, any “preferred” embodiments, are merely possible examples of implementations, merely set forth for a clear understanding of the principles of the disclosed system and method. Many variations and modifications may be made to the above-described embodiments of the disclosure without departing substantially from the spirit and principles of the disclosure. All such modifications and variations are intended to be included herein within the scope of this disclosure and protected by the following claims.

What is claimed is:

1. A strategy game based on a sporting event, the strategy game comprising:
a processor; and
a computer readable storage medium tangibly embodying code executed by the processor to cause operations to be performed, the operations comprising:
electronically publishing at least one strategy question during a sporting event relating to an impending coaching decision of the sporting event via at least one network connection of the computerized data processing apparatus;
electronically publishing a plurality of possible answers to the at least one strategy question;
recording a user answer selected from the possible answers published from each of a plurality of game users;
recording a coaching answer selected from the possible answers that correlate to a coaching decision made by a coach with the impending coaching decision during the sporting event; and
publishing data correlating the recorded user answers and the recorded coaching answer.

2. The strategy game of claim 1, the operations further comprising:
recording whether the coaching decision was successful, whereby successful is based on pre-established guidelines of success; and
publishing data correlating the recorded successfulness of the coaching decision and at least one of: the recorded user answers and the recorded coaching answer.

3. The strategy game of claim 1, wherein the operation of recording the user answer selected further comprises the operation of receiving the user answer through a computer network.

4. The strategy game of claim 3, wherein the user provides the user answer through a mobile computing device.

5. The strategy game of claim 1, wherein the operation of electronically publishing at least one strategy question further comprises the operations of:
storing a plurality of fungible strategy questions in the computer readable storage medium;
identifying sporting event situations appropriate for each of the fungible strategy questions;
tagging the fungible strategy questions with data representing the appropriate sporting event situations for the questions; and
electronically publishing the at least one strategy question when a sporting event situation matches the identified appropriate sporting event situation for the at least one strategy question.

6. The strategy game of claim 5, further comprising the operations of:
maintaining at least one variable field in the at least one strategy question, whereby the variable field corresponds to a characteristic of the sporting event;
tracking a plurality of event characteristics during the sporting event; and
electronically publishing the at least one strategy question with the variable field filled with one of the tracked event characteristics.

7. The strategy game of claim 1, wherein electronically publishing the at least one strategy question further comprises publishing a plurality of strategic questions during one sporting event; and
wherein the operation of publishing data further comprises publishing data correlating a plurality of one user's recorded answers and a plurality of the recorded coaching answers for the one sporting event.

8. The strategy game of claim 1, wherein electronically publishing the at least one strategy question further comprises publishing a plurality of strategic questions during one sporting event;
wherein the plurality of game users further comprises a first user and a second user; and
wherein the operation of publishing data further comprises publishing data comparing a plurality of a first user's recorded answers and a plurality of a second user's recorded answers for the one sporting event.

9. The strategy game of claim 8, further comprising publishing a number of the first user's recorded answers that matched coaching answers and were successful and publishing a number of the second user's recorded answers that matched coaching answers and were successful.

10. The strategy game of claim 1, wherein electronically publishing the at least one strategy question further comprises publishing a plurality of strategic questions during each of a plurality of sporting events; and the game further comprises:
tracking a plurality of coaching answers for a plurality of coaches;
identifying a least one coaching common pattern of decision-making for each of the plurality of coaches;
identifying at least one user common pattern of decision-making for a first user of the plurality of game users; and
publishing to the first user an identity of a coach with the coaching common pattern similar to the user common pattern of the first user.

11. A method for providing a network-based strategy game based on live sporting events, the method comprising the steps of:
electronically publishing at least one strategy question during a sporting event relating to an impending coaching decision of the sporting event via at least one network connection of a computerized data processing apparatus having a processor and a computer readable storage medium containing the code to publishing data on the computer network;
electronically publishing multiple choice answers to at least one strategy question across the computer network;
recording a user answer from the multiple choice answers published from each of a plurality of game users selecting remotely on the computer network;
recording a coaching answer selected from the multiple choice answers that correlate to a coaching decision made by a coach participating in the sporting event;
recording whether the coaching decision was successful, whereby successful is based on pre-established guidelines of success; and
publishing data on the computer network correlating at least two of: the recorded user answers, the recorded coaching answer, and the recorded successfulness of the coaching decision.

12. The method of claim 11, wherein the pre-established guidelines of success are stored in the computer readable storage medium and the processor compares information from the sporting event received from a data feed to the pre-established guidelines of success and to determine whether the coaching decision was successful.

13. The method of claim 12, wherein the user provides the user answer through a mobile computing device.

14. The method of claim 11, wherein the step of electronically publishing at least one strategy question further comprises the steps of:
storing a plurality of fungible strategy questions in the computer readable storage medium;
identifying sporting event situations appropriate for each of the fungible strategy questions;
tagging the fungible strategy questions with data representing the appropriate sporting event situations for the questions; and
electronically publishing a specific one of the fungible strategy questions when a sporting event situation matches the identified appropriate sporting event situation for the specific fungible strategy question.

15. The method of claim 14, further comprising the steps of:
maintaining at least one variable field in the at least one strategy question, whereby the variable field corresponds to a characteristic of the sporting event;
tracking a plurality of event characteristics during the sporting event; and
electronically publishing the at least one strategy question with the variable field filled with one of the tracked event characteristics.

16. The method of claim 11, wherein electronically publishing the at least one strategy question further comprises publishing a plurality of strategic questions during one sporting event, each having a corresponding recorded user answer, coaching answer, and recorded successfulness; and
wherein the step of publishing data further comprises publishing data on the computer network correlating at least two of: a plurality of the recorded user answers, a plurality of the recorded coaching answers, and a plurality of the recorded successfulness of the coaching decisions.

17. The method of claim 11, wherein electronically publishing the at least one strategy question further comprises publishing a plurality of strategic questions during one sporting event;
wherein the plurality of game users further comprises a first user and a second user; and
wherein the step of publishing data further comprises publishing data comparing a plurality of a first user's recorded answers and a plurality of a second user's recorded answers for the one sporting event.

18. The method of claim 17, further comprising the step of publishing a number of the first user's recorded answers that matched coaching answers and were successful and publishing a number of the second user's recorded answers that matched coaching answers and were successful.

19. The method of claim 11, wherein electronically publishing the at least one strategy question further comprises publishing a plurality of strategic questions during each of a plurality of sporting events; and the game further comprises the steps of:
tracking a plurality of coaching answers for a plurality of coaches;
identifying a least one coaching common pattern of decision-making for each of the plurality of coaches;
identifying at least one user common pattern of decision-making for a first user of the plurality of game users; and
publishing to the first user an identity of a coach with the coaching common pattern similar to the user common pattern of the first user.
